(19) United States
(12) Patent Application Publication
(10) Pub. No.: US 2025/0275013 A1
(43) Pub. Date: Aug. 28, 2025

(54) Multicast and Broadcast Services in Radio Access Network Sharing Deployments

(71) Applicant: Apple Inc., Cupertino, CA (US)

(72) Inventors: Fangli Xu, Beijing (CN); Haijing Hu, Los Gatos, CA (US); Yuqin Chen, Beijing (CN); Dawei Zhang, Saratoga, CA (US); Alexander Sirotkin, Hod Hasharon (IL); Peng Cheng, Beijing (CN); Zhibin Wu, Los Altos, CA (US); Naveen Kumar R Palle Venkata, San Diego, CA (US); Sethuraman Gurumoorthy, San Jose, CA (US)

(21) Appl. No.: 18/858,219

(22) PCT Filed: Jun. 10, 2022
(86) PCT No.: PCT/CN2022/098154

§ 371 Date: Oct. 18, 2024

(51) Int. Cl. H04W 76/40; H04W 72/121; H04W 84/04

(52) U.S. Cl. CPC H04W 76/40; H04W 72/121; H04W 84/042

(57) ABSTRACT

This disclosure relates to techniques for providing multicast and broadcast services in a wireless communication system with radio access network sharing. A cellular base station that is associated with multiple public land mobile networks may receive multicast and broadcast services session setup information for a multicast and broadcast services session. The cellular base station may determine that the session is associated with multiple public land mobile networks. The cellular base station may configure the multicast and broadcast services session that is associated with the multiple public land mobile networks.

### PRIORITY INFORMATION

This application is a national stage entry of PCT Application No. PCT/CN2022/098154, entitled “Multicast and Broadcast Services in Radio Access Network Sharing Deployments,” filed Jun. 10, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for providing multicast and broadcast services in a wireless communication system with radio access network sharing.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, cHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for providing multicast and broadcast services in a wireless communication system with radio access network sharing.

The techniques described herein may support provision of a multicast and broadcast services session that is associated with multiple cellular networks by a cellular base station in a radio access network sharing deployment. Such provision may be more efficient than separately providing multicast and broadcast services sessions for the same service for the different cellular networks associated with the cellular base station, for example since duplication of the content and at least some of the signaling may be avoided in this way.

The provision of a multicast and broadcast services session that is associated with multiple cellular networks may be accomplished at least in part by providing a mechanism for identifying that multiple cellular networks wish to perform session setup for the same multicast or broadcast service, which may in turn enable the cellular base station to configure one session for the multicast or broadcast service instead of separately configuring a session for the multicast or broadcast service for each of the cellular networks that wish to perform session setup for the multicast or broadcast service.

Several such possible mechanisms are described herein, including techniques for establishing a shared/unified temporary mobile group identifier framework across multiple network operators, as well as various techniques for allowing multiple temporary mobile group identifiers to be associated with one multicast and broadcast services session.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, cellular core network infrastructure devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 illustrates an exemplary block diagram of a cellular network element, according to some embodiments;

FIG. 6 is a flowchart diagram illustrating aspects of an exemplary possible method for providing multicast and broadcast services in a wireless communication system with radio access network sharing, according to some embodiments;

FIG. 7 illustrates aspects of a possible RAN sharing scenario in which the same multicast/broadcast service is provided by multiple operators, according to some embodiments;

FIG. 8 illustrates example aspects of a possible TMGI structure, according to some embodiments;

FIG. 9 illustrates aspects of a possible scenario in which a shared/unified TMGI is used across different PLMNs, according to some embodiments;

FIG. 10 is a signal flow diagram illustrating example network communication aspects of the scenario of FIG. 9, according to some embodiments;

FIG. 11 illustrates aspects of another possible scenario in which a shared/unified TMGI is used across different PLMNs, according to some embodiments;

FIG. 12 is a signal flow diagram illustrating example network communication aspects of the scenario of FIG. 11, according to some embodiments;

FIG. 13 is a signal flow diagram illustrating network communication aspects of an example scenario in which multiple TMGIs can be associated with one MBS service/session, according to some embodiments;

FIG. 14 is a signal flow diagram illustrating further details of an example scenario in which the MBS service ID field in the TMGI may be unified across the shared operators/PLMNs, according to some embodiments;

FIG. 15 is a signal flow diagram illustrating further details of an example scenario in which the association between multiple TMGIs can be configured to a gNB that is part of a RAN sharing deployment via OAM or other means, according to some embodiments;

FIG. 16 is a signal flow diagram illustrating further details of an example scenario in which a new global MBS service ID may be introduced to associate multiple TMGIs with the same MBS service, according to some embodiments;

FIG. 17 is a signal flow diagram illustrating further details of an example scenario in which a special carrier can be configured to provide one MBS service, according to some embodiments; and

FIG. 18 is a signal flow diagram further details of possible UE operation in a scenario in which multiple TMGIs can be associated with one MBS multicast service/session, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
RAN: Radio Access Network
TRP: Transmission-Reception-Point
PLMN: Public Land Mobile Network
MBS: Multicast and Broadcast Services
TMGI: Temporary Mobile Group Identifier

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

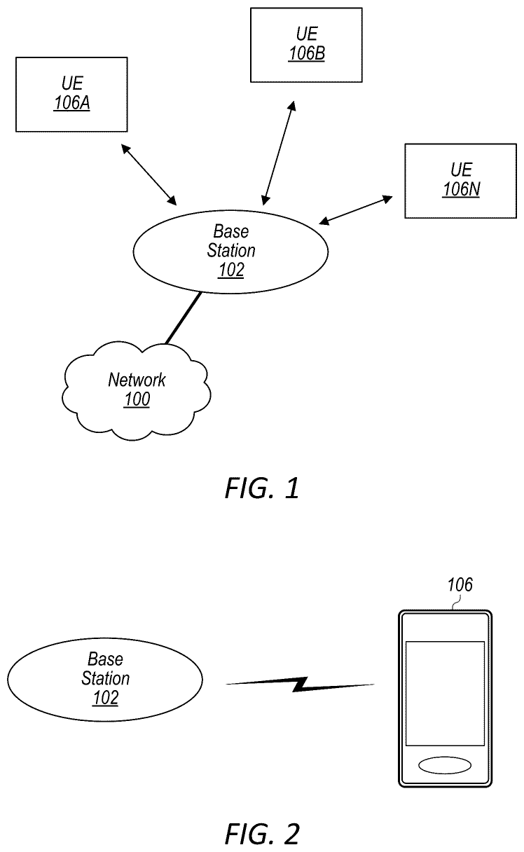

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, cHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for receiving multicast and broadcast services in a wireless communication system with radio access network sharing, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

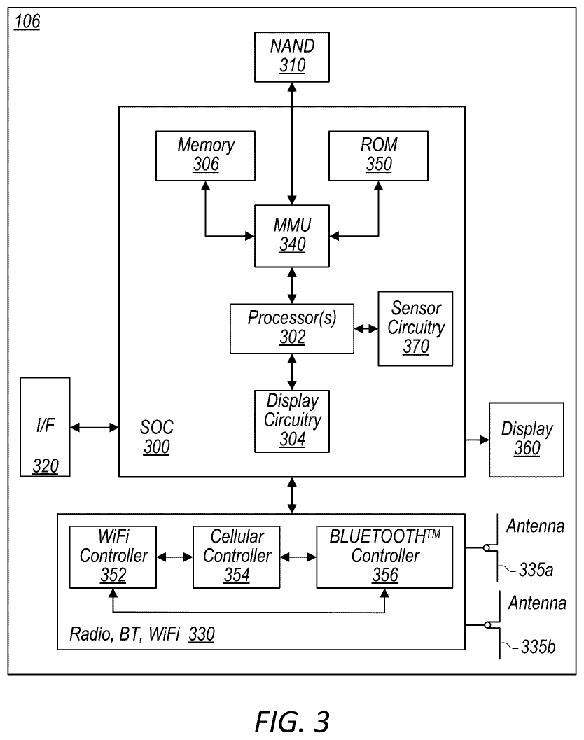

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform techniques for receiving multicast and broadcast services in a wireless communication system with radio access network sharing, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform techniques for receiving multicast and broadcast services in a wireless communication system with radio access network sharing according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

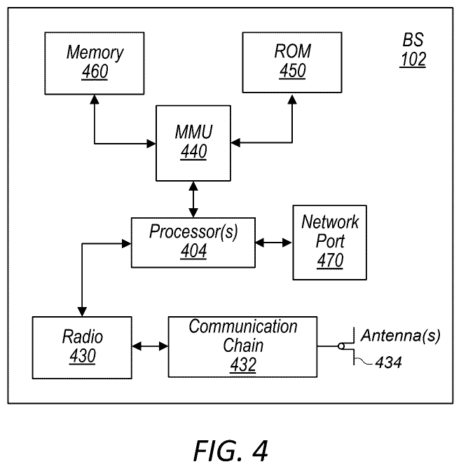

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

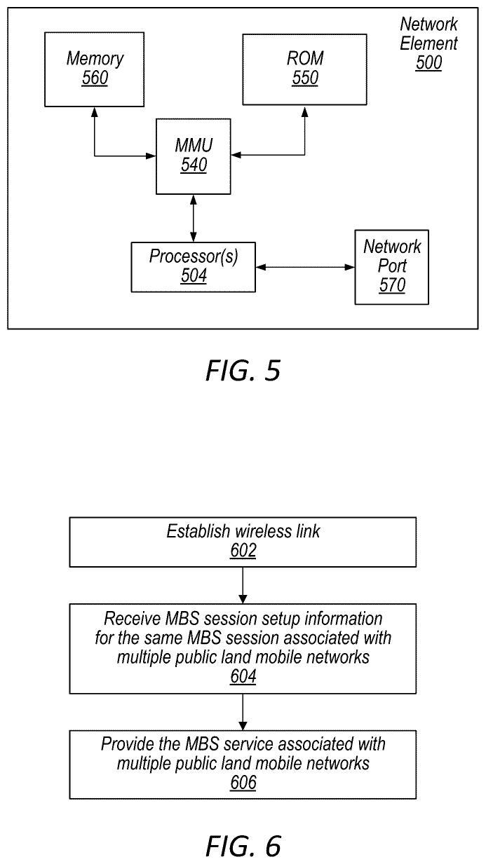

### FIG. 5—Exemplary Block Diagram of a Network Element

FIG. 5 illustrates an exemplary block diagram of a network element 500, according to some embodiments. According to some embodiments, the network element 500 may implement one or more logical functions/entities of a cellular core network, such as a mobility management entity (MME), serving gateway (S-GW), access and management function (AMF), session management function (SMF), etc. It is noted that the network element 500 of FIG. 5 is merely one example of a possible network element 500. As shown, the core network element 500 may include processor(s) 504 which may execute program instructions for the core network element 500. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The network element 500 may include at least one network port 570. The network port 570 may be configured to couple to one or more base stations and/or other cellular network entities and/or devices. The network element 500 may communicate with base stations (e.g., cNBs/gNBs) and/or other network entities/devices by means of any of various communication protocols and/or interfaces.

As described further subsequently herein, the network element 500 may include hardware and software components for implementing and/or supporting implementation of features described herein. The processor(s) 504 of the core network element 500 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof.

### FIG. 6—Multicast and Broadcast Services in Radio Access Network Sharing Deployments

Network sharing may include the practice of sharing network equipment between multiple network operators. Network sharing may be implemented at the radio access network (RAN) level, for example including deploying one or more cellular base stations that can provide service associated with any of multiple public land mobile networks (PLMNs) to wireless devices, at least as one possible aspect of a network sharing deployment. Such a deployment may have the potential to reduce network capital expenditures by the network operators, to more efficiently provide service to wireless devices, and/or provide other benefits, at least in some instances.

In order to realize such potential, it may be beneficial to introduce new techniques and/or features to support enhanced network resource use efficiency in conjunction with such network sharing deployments. For example, it may be possible to introduce techniques for providing multicast and broadcast services in a wireless communication system with RAN sharing, which may provide such improved efficiency. FIG. 6 is a flowchart diagram illustrating aspects of such a method, at least according to some embodiments.

Aspects of the method of FIG. 6 may be implemented by a cellular base station, e.g., in conjunction with one or more wireless devices and/or other cellular network elements, such as a UE 106, a BS 102, and a cellular network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 6 are described in a manner relating to the use of communication techniques and/or features associated with 3GPP and/or NR specification documents, such description is not intended to be limiting to the disclosure, and aspects of the method of FIG. 6 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 6 may operate as follows.

In 602, the wireless device may establish a wireless link with a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible, and the cellular network may also or alternatively operate according to another cellular communication technology (e.g., UMTS, CDMA2000, GSM, etc.), according to various embodiments.

In some embodiments, the cellular base station may be part of a radio access network (RAN) sharing deployment, and may be associated with multiple public land mobile networks (PLMNs), for example including at least a first PLMN and a second PLMN. In such a scenario, it may be the case that the cellular base station is able to provide home PLMN (HPLMN) service to wireless devices associated with either of the first PLMN or the second PLMN. In other words, the cellular base station may be able to serve (at least) a first wireless device that is associated with the first PLMN, as well as (at least) a second wireless that is associated with the second PLMN, without either the first wireless device or the second wireless device needing to roam to access the service. Note that it may also be possible for the cellular base station to be associated with more than two PLMNs, at least in some instances.

Establishing the wireless link may include establishing a RRC connection with a serving cellular base station, at least according to some embodiments. Establishing the first RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

At least in some instances, establishing the wireless link(s) may include the wireless device providing capability information for the wireless device. Such capability information may include information relating to any of a variety of types of wireless device capabilities.

In 604, the cellular base station may receive multicast and broadcast services (MBS) session setup information for a MBS session. The cellular base station may determine that the MBS session is associated with multiple PLMNs. The association of the MBS session with the multiple PLMNs may be identified in any of a variety of ways.

In some embodiments, the association of the MBS session with the multiple PLMNs may be identified based at least in part on the cellular base station receiving MBS session setup information for the MBS session from each of the multiple PLMNs. For example, the cellular base station may receive MBS session setup information for the MBS session from a network entity (e.g., AMF and/or multicast broadcast session management function (MB-SMF)) associated with the first PLMN, and may also receive MBS session setup information for the MBS session from a network entity (e.g., AMF and/or MB-SMF) associated with the second PLMN. In such a scenario, the MBS session setup information may include information that can be used by the cellular base station (e.g., on its own or in conjunction with other information available to the cellular base station) to determine that the multiple PLMNs are requesting that the same MBS service be provided in a MBS session.

As one such possibility, some or all of the networks with the RAN sharing deployment may coordinate to pre-configure the cellular base station with information indicating that certain temporary mobile group identifiers (TMGIs) are associated. For example, the cellular base station may receive an indication that certain TMGIs are associated (e.g., that they are used to refer to the same MBS service by different PLMNs), for example by operations, administration, and maintenance (OAM) configuration. Thus, the cellular base station could receive an indication that a first TMGI and a second TMGI are associated. In such a scenario, the MBS session setup information received from the network entity associated with the first PLMN could indicate the first TMGI for the MBS session, and the MBS session setup information received from the network entity associated with the second PLMN could indicate the second TMGI for the MBS session. Based on the TMGIs indicated for the MBS session and the pre-configured association between the TMGIs, the cellular base station may be able to identify that both PLMNs are configuring the same MBS service, and accordingly may associate the MBS session with both the first PLMN and the second PLMN.

As another such possibility, some or all of the networks with the RAN sharing deployment may coordinate to unify their use of the MBS service identification (ID) field of their TMGIs across the multiple PLMNs. For example, in such a scenario, the MBS session setup information received from the network entity associated with the first PLMN could indicate a first TMGI for the MBS session, and the MBS session setup information received from the network entity associated with the second PLMN could indicate a second TMGI for the MBS session, and the MBS service ID field for the first TMGI and the second TMGI could be identical. Based on the TMGIs indicated for the MBS session including identical MBS service ID fields, the cellular base station may be able to identify that both PLMNs are configuring the same MBS service, and accordingly may associate the MBS session for that MBS service with both the first PLMN and the second PLMN.

As a further possibility, even if the MBS service ID field of their TMGIs may not be unified across the multiple PLMNs, it may be possible for some or all of the networks with the RAN sharing deployment to coordinate to use a separate unified MBS service identification framework. For example, it could be the case that the MBS session setup information received from the network entity associated with the first PLMN includes MBS service identification information (e.g., separate from the TMGI) that uniquely identifies the MBS session across multiple PLMNs, and that the MBS session setup information received from the network entity associated with the second PLMN also includes such MBS service identification information that uniquely identifies the MBS session across multiple PLMNs, and that the MBS service identification information in the MBS session setup information received from both network entities is identical. In such a scenario, the cellular base station may be able to identify that both PLMNs are configuring the same MBS service based at least in part on the MBS service identification information indicated for the MBS session being identical, and accordingly may associate the MBS session for that MBS service with both the first PLMN and the second PLMN.

As a still further possibility, a special component carrier and/or service area may be configured to provide one MBS session. For example, the MBS session setup information received from the network entity associated with the first PLMN may indicate to setup the MBS session using a component carrier that has been configured (e.g., by the cellular base station) to provide one MBS session. MBS session setup information may also be received by the cellular base station for the MBS session from the network entity associated with the second PLMN indicating to setup the MBS session using the component carrier configured to provide one MBS session. In such a scenario, the cellular base station may determine that the MBS session is associated with both the first PLMN and the second PLMN based at least in part on the MBS session setup information received from both PLMNs indicating to setup the MBS session using the component carrier configured to provide one MBS session. As another example, the MBS session setup information received from the network entity associated with the first PLMN may indicate to setup the MBS session using a service area that has been configured (e.g., by the cellular base station) to provide one MBS session. MBS session setup information may also be received by the cellular base station for the MBS session from the network entity associated with the second PLMN indicating to setup the MBS session using the service area configured to provide one MBS session. In such a scenario, the cellular base station may determine that the MBS session is associated with both the first PLMN and the second PLMN based at least in part on the MBS session setup information received from both PLMNs indicating to setup the MBS session using the service area configured to provide one MBS session.

As yet another possibility, it may be the case that some or all of the networks with the RAN sharing deployment can coordinate a shared/unified TMGI design between their PLMNs to be able to identify an MBS service that is being set up at a cellular base station that is part of a RAN sharing deployment between them. In other words, it may be possible to coordinate a TMGI design such that a shared TMGI can be designed to uniquely identify a MBS service across multiple PLMNs. For example, a shared mobile network code (MNC) for the coordinating combination of PLMNs could be defined, and the MBS session setup information for the MBS session could include the shared MNC value in the MNC field of the TMGI for the MBS service. At least in some instances, the MBS service ID field of the TMGI may also be unified across the multiple PLMNs for the same MBS service. In such a scenario, the cellular base station may be able to associate the MBS session for the MBS service with both the first PLMN and the second PLMN based on the TMGI for the MBS session being associated with both the first PLMN and the second PLMN.

Note that in such a scenario, it may be possible for the cellular base station to identify that the MBS session is associated with both the first PLMN and the second PLMN even if MBS session setup information is only received from one or the other of the first PLMN or the second PLMN, at least in some embodiments. It may also be possible that the cellular base station receives MBS session setup information for the MBS session from both the first PLMN and the second PLMN. In such a scenario, it may be the case that the identical shared TMGI is indicated for the MBS session by both PLMNs, and the cellular base station may be able to determine that both MBS session setup requests are referring to the same MBS service based at least in part on the TMGI in both MBS session setup requests being identical.

Note that in addition or alternatively to the mechanisms described herein, other mechanisms for determining to associate a MBS session with multiple PLMNs are also possible.

In 606, the cellular base station may configure the MBS session associated with the multiple PLMNs, and may provide the associated MBS service, potentially including to the wireless device and other wireless devices served by the cellular base station, which may include wireless devices associated with either or both of the first PLMN or the second PLMN, according to various embodiments.

Configuring the MBS session may be performed in a manner that may depend at least in part on the manner in which the cellular base station identifies that the MBS session is identified with multiple PLMNs. For example, in various scenarios in which different TMGIs (e.g., that are associated with the different PLMNs) are configured by the different PLMNs when performing MBS session setup, the cellular base station may configure the MBS session with the multiple different TMGIs (e.g., at least a first TMGI and a second TMGI). This may allow wireless devices served by the cellular base station to identify that the MBS session is associated with each of the PLMNs associated with the TMGIs configured for the MBS session. At least in some instances, this may allow a wireless device to receive content for the MBS session that is identified via a TMGI that is associated with a PLMN that is not associated with the wireless device. For example, a first TMGI indicated for the MBS session may be associated with a PLMN that is associated with the wireless device, while a second TMGI indicated for the MBS session may be associated with a PLMN that is not associated with the wireless device. In this example scenario, it may be possible that the wireless device receives content for the MBS session that is identified via the second TMGI, and that the wireless device can identify that the content is for the MBS session based at least in part on the second TMGI. As another example, if the MBS session is a multicast MBS session, a first TMGI for the MBS session is associated with a PLMN that is associated with a wireless device, and a second TMGI for the MBS session is associated with a PLMN that is not associated with the wireless device, the wireless device could receive paging for the multicast MBS session for the second TMGI, and may be able to trigger a connection to receive the multicast MBS session based at least in part on the second TMGI.

As another possibility, in scenarios in which a unified/shared TMGI framework is established between coordinating networks, and such a shared TMGI is provided when performing MBS session setup, the cellular base station may configure the MBS session with the shared TMGI. In such a scenario, the wireless device may be able to identify that the MBS session is associated with at least one PLMN that is associated with the wireless device, and accordingly that the wireless device may be able to subscribe to and receive content for the MBS session.

Note that in some embodiments, if MBS service identification information that uniquely identifies the MBS session across multiple PLMNs is provided to the cellular base station (and potentially used to identify that the MBS session is associated with multiple PLMNs), such MBS service identification information may be provided as part of the MBS session configuration, if desired. Such information may be used to identify the MBS service provided by the MBS session. Additionally, or alternatively, the for multicast use cases, the network may be able to use such information to indicate the MBS multicast activation in the notification paging for the MBS session. Alternatively, it may be possible that even if such MBS service identification information is provided to the cellular base station, the information is transparent (e.g., not provided) to the wireless device (e.g., during MBS session configuration or otherwise). In such a scenario, existing mechanisms for identifying interested service(s) may be used by the wireless device, such as the MBS service ID field included in the TMGI(s) for the MBS session.

Thus, at least according to some embodiments, the method of FIG. 6 may be used to provide a framework according to which a shared RAN can provide broadcast and multicast services in a resource-efficient manner, at least in some instances. For example, using the techniques described herein, when the same broadcast or multicast service is to be provided from an application function (e.g., via one or more cellular core networks) to a shared cellular base station and on to wireless devices (e.g., including devices associated with multiple networks that share the cellular base station) served by the cellular base station, it may be possible to make use of the network sharing arrangement to avoid duplicating provision of the service from the cellular base station to wireless devices associated with different networks. This may result in more efficient network resource usage than if the broadcast or multicast service were provided separately for each of the networks that share the cellular base station, at least according to some embodiments.

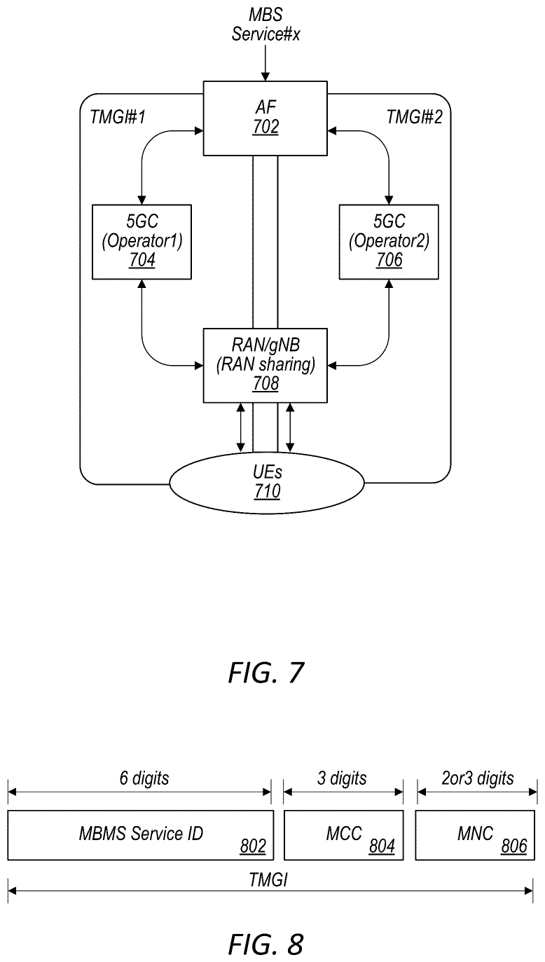

### FIGS. 7-18 and Additional Information

FIGS. 7-18 illustrate further aspects that might be used in conjunction with the method of FIG. 6 if desired. It should be noted, however, that the exemplary details illustrated in and described with respect to FIGS. 7-18 are not intended to be limiting to the disclosure as a whole: numerous variations and alternatives to the details provided herein below are possible and should be considered within the scope of the disclosure.

In 3GPP Release 17 NR Multicast and Broadcast Services (MBS) design, a MBS service/session may be identified by a temporary mobile group identifier (TMGI), which may be assigned by the 5G core (5GC) network. The TMGI (e.g., even for the same service) may be different for different public land mobile networks (PLMNs) and network operators. In the 5GC-radio access network (RAN) interface, a MBS broadcast/multicast shared session may be setup per MBS session. With respect to the RAN, the gNB may provide the configuration and transmission for the MBS multicast/broadcast service using a MBS radio bearer. In some instances, one MRB may be allowed to be associated with at most one MBS session and TMGI. Further aspects and details of 3GPP Release 17 NR MBS design, at least according to some embodiments, can be found in 3GPP TS 23.003 v.17.5.0, 3GPP TS 38.331 v.17.0.0, and 3GPP TS 38.413 v.17.0.0.

Network sharing may be a practice that includes the sharing of cellular network infrastructure equipment between multiple network operators, for example to reduce network capital expenditures. In a RAN sharing deployment, if the same multicast/broadcast service is provided by two (or more) operators separately, it could potentially be the case that this service would be recognized as separate TMGIs, which could result in duplicated point-to-multipoint (PTM) radio resource consumption in the same cell for transmission of the same content. FIG. 7 illustrates aspects of such a possible scenario, according to some embodiments. As shown, for an MBS service (“MBS Service #x”), an application function (AF) 702 may provide the MBS service to one 5GC 704 operated by one operator (“Operator1”) with TMGI #1, and may provide the MBS service to another 5GC 706 operated by another operator (“Operator2”) with TMGI #2. The service may be provided in duplicate to the shared RAN/gNB 708, which may in turn duplicate provision of the MBS Service #x from the same serving cell (shared by operator 1 and operator2) to UEs 710 served by the cell. This separate/duplicated PTM resource allocation for different operators may be a relatively inefficient use of resources.

Accordingly, it may be beneficial to provide techniques that can more efficiently manage MBS resources in RAN sharing scenarios, at least in some instances. There may be a variety of possible approaches to improving the resource use efficiency for MBS sessions in RAN sharing scenarios, including approaches in which a shared/unified TMGI design can be supported across different PLMNs, and approaches in which multiple TMGIs can be associated with one MBS service/session, among various possibilities.

FIG. 8 illustrates example aspects of a possible TMGI structure, according to some embodiments. As shown, the structure may include a 6 digit MBMS Service ID field 802, a 3 digit MCC field 804, and a 2 or 3 digit MNC field 806. In an approach in which a shared TMGI design is supported, it may be possible for operators to coordinate the TMGI allocation, e.g., such that the same TMGI can be used by multiple PLMNs to identify the same MBS service. Operators employing such an approach may coordinate to ensure that the same MBMS Service ID is used for the same MBMS service by each of the operators with a RAN sharing deployment. Additionally, a shared PLMN ID could be defined for each combination of network operators with a RAN sharing deployment, which may be used to ensure that the MNC field of the TMGI can be uniform across each set of network operators with a RAN sharing deployment, at least according to some embodiments.

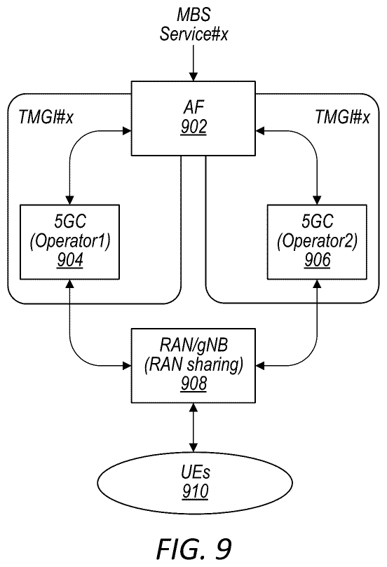

FIG. 9 illustrates aspects of a possible scenario in which a shared/unified TMGI is used across different PLMNs, according to some embodiments. As shown, in the illustrated scenario, for an MBS service (“MBS Service #x”), an AF 902 may provide the MBS service to one 5GC 904 operated by one operator (“Operator1”) with TMGI #x, and may provide the MBS service to another 5GC 906 operated by another operator (“Operator2”) also with TMGI #x. The service may be provided in duplicate to the shared RAN/gNB 908, which may recognize that the same MBS service #x is being received from both 5GCs, and may setup a single MBS session for the MBS Service #x from the serving cell to UEs 910 served by the cell.

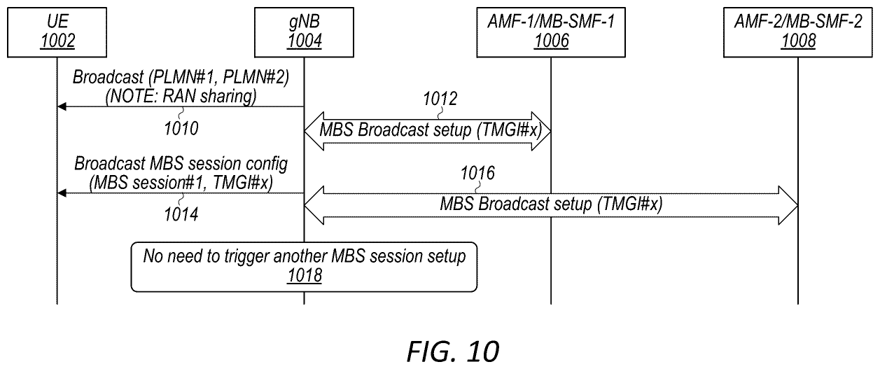

FIG. 10 is a signal flow diagram illustrating example network communication aspects of the scenario of FIG. 9, according to some embodiments. The illustrated scenario may include communication between a UE 1002, gNB 1004, AMF-1/MB-SMF-1 1006, and AMF-2/MB-SMF-2 1008. As shown, in 1010, the gNB 1004 may establish a broadcast configuration with the UE 1002 in which PLMN #1 and PLMN #2 have RAN sharing. In 1012, the AMF-1/MB-SMF-1 1006 may perform MBS broadcast setup with gNB 1004 for TMGI #x. In 1014, the gNB 1004 may provide broadcast MBS session configuration for MBS session #1 with TMGI #x. In 1016, the AMF-2/MB-SMF-2 1008 may perform MBS broadcast setup with gNB 1004 for TMGI #x. In 1018, the gNB 1004 may recognize that the MBS session setup request is for the same MBS service (from the different 5GC). For the duplicated request from the different 5GC/operator, the gNB may not need to setup another MBS session or declare a failure, at least according to some embodiments.

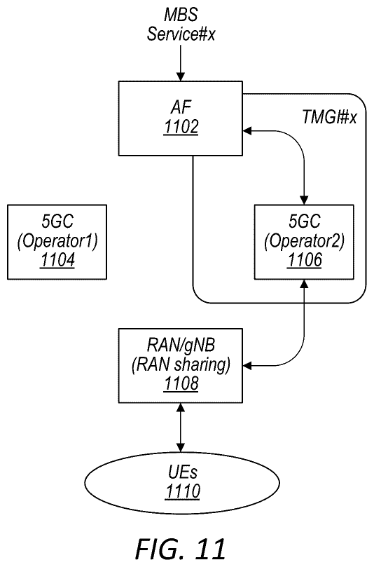

FIG. 11 illustrates aspects of another possible scenario in which a shared/unified TMGI is used across different PLMNs, according to some embodiments. As shown, in the illustrated scenario, for an MBS service (“MBS Service #x”), an AF 1102 may provide the MBS service to one 5GC 1106 operated by Operator2 with TMGI #x. In the illustrated scenario, the AF may be aware of the RAN sharing configuration between operators and may not provide the MBS service to the 5GC 1104 operated by Operator1. The service may be provided to the shared RAN/gNB 1108, which may setup a single MBS session for the MBS Service #x from the serving cell to UEs 1110 served by the cell.

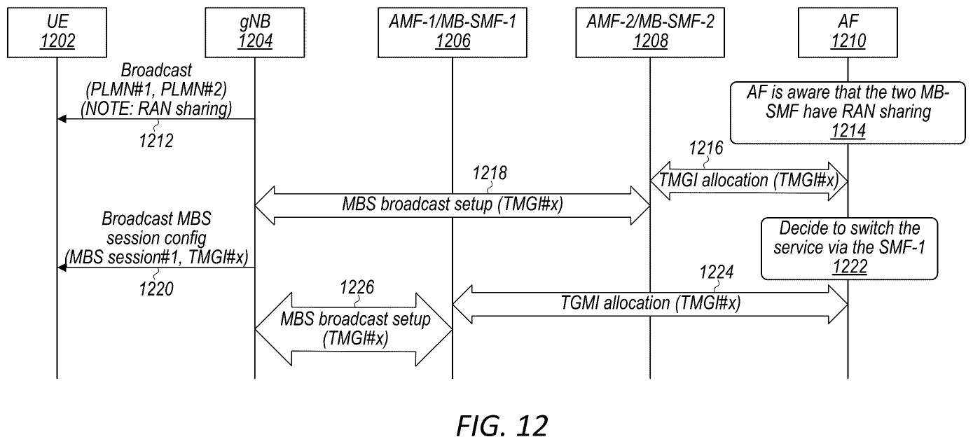

FIG. 12 is a signal flow diagram illustrating example network communication aspects of the scenario of FIG. 11, according to some embodiments. The illustrated scenario may include communication between a UE 1202, gNB 1204, AMF-1/MB-SMF-1 1206, AMF-2/MB-SMF-2 1208, and AF 1210. As shown, in 1212, the gNB 1204 may establish a broadcast configuration with the UE 1202 in which PLMN #1 and PLMN #2 have RAN sharing. In 1214, the AF may be aware that the two MB-SMF have a RAN sharing deployment. The AF may be preconfigured with which operators share RAN deployments in the Uu interface, at least according to some embodiments. In 1216, the AF 1210 may provide TMGI allocation (TMGI #x) to AMF-2/MF-SMF-2 1208. In 1218, the AMF-2/MB-SMF-2 1208 may perform MBS broadcast setup with gNB 1204 for TMGI #x. In 1220, the gNB 1204 may provide broadcast MBS session configuration for MBS session #1 with TMGI #x.

In 1222, the AF 1210 may decide to switch the service to the AMF-1/MB-SMF-1 1206. Note that it may be the case that such triggering of the MBS session setup via another operator after a previous setup of the MBS session has already been performed may generally not be needed, but may be performed in case of failure of the previous setup and/or based on other events (e.g., network congestion, as one possibility), if desired. In 1224, the AF may provide TMGI allocation (TMGI #x) to AMF-1/MB-SMF-1 1206. In 1226, the AMF-1/MB-SMF-1 1206 may perform MBS broadcast setup with gNB 1204 for TMGI #x.

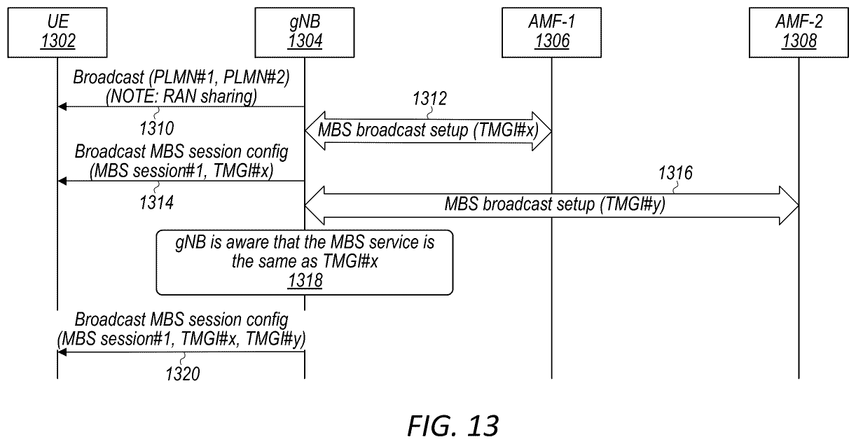

As previously noted herein, an approach in which multiple TMGIs can be associated with one MBS service/session may be another possibility for efficiently providing multicast and broadcast services in RAN sharing deployments. FIG. 13 is a signal flow diagram illustrating network communication aspects of one such example scenario, according to some embodiments. The illustrated scenario may include communication between a UE 1302, gNB 1304, AMF-1 1306, and AMF-2 1308. As shown, in 1310, the gNB 1304 may establish a broadcast configuration with the UE 1302 in which PLMN #1 and PLMN #2 have RAN sharing.

In 1312, the AMF-1 1306 may perform MBS broadcast setup with gNB 1304 for TMGI #x. In 1314, the gNB 1304 may provide broadcast MBS session configuration for MBS session #1 with TMGI #x. In 1316, the AMF-2 1308 may perform MBS broadcast setup with gNB 1304 for TMGI #y. In 1318, the gNB may be aware that the MBS service for TMGI #y is the same as for TMGI #x. The gNB may provide the MRB and MBS traffic channel (MTCH) configuration per MBS service, e.g., such that a MRB can be associated with multiple TMGIs. Accordingly, in 1320, the gNB 1304 may provide broadcast MBS session configuration for MBS session #1 with both TMGI #x and TMGI #y. Note that the AMF may be able to configure the gNB such that the RAN sharing operation or a specific MBS service is only applied on a specific carrier, e.g., via the MBS Service Area Information IE in the 5GC-RAN interface, if desired.

For UE operation, it may also be possible that a UE can be configured with one MRB/MTCH associated with multiple TMGIs. The UE may be able to identify the MBS service not only via its own TMGI, but also via other TMGI that are associated to the same MRB/MTCH. For the MBS multicast activation notification, it may be possible for a UE to activate a MBS multicast session when any associated TMGI is indicated in the paging.

In the centralized unit (CU)—distributed unit (DU) interface, the MBS service/MRB setup may also be mapped onto multiple TMGIs that are configured to the same MBS service.

For such an approach, there may further be a variety of possible techniques for making the gNB aware of an association between TMGIs. As one possibility, the MBS service ID field in the TMGI may be unified across the shared operators/PLMNs, which could be used to identify the multicast/broadcast service as being the same for different TMGIs. As another possibility, the association of multiple TMGIs with each other can be configured to the gNB via operations, administration, and maintenance (OAM) means or other means. As a still further possibility, a new global MBS service ID may be introduced to associate with the MBS service, which may be linked to multiple TMGIs. As yet another possibility, it may be possible to associate a MBS service to a special carrier, which may be specified or defined such that all TMGIs that are delivered on the special carrier refer to the same MBS session.

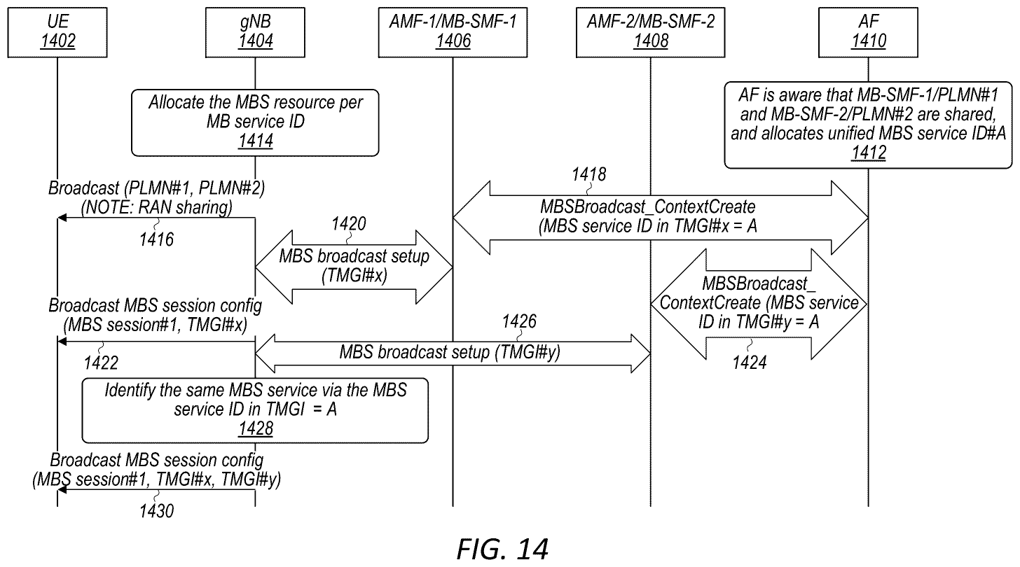

FIG. 14 is a signal flow diagram illustrating further details of an example scenario in which the MBS service ID field in the TMGI may be unified across the shared operators/PLMNs, according to some embodiments. The illustrated scenario may include communication between a UE 1402, gNB 1404, AMF-1/MB-SMF-1 1406, AMF-2/MB-SMF-2 1408, and AF 1410. As shown, in 1412, the AF may be aware that MB-SMF-1/PLMN #1 and MB-SMF-2/PLMN #2 are shared, and may allocate unified MBS service ID #A for a MBS service. In 1414, the gNB 1404 may be configured to allocate the MBS resource per MB service ID (e.g., rather than per TMGI). In 1416, the gNB 1404 may establish a broadcast configuration with the UE 1402 in which PLMN #1 and PLMN #2 have RAN sharing. In 1418, the AF 1410 may create a MBS broadcast context with AMF-1/MB-SMF-1 1406, with TMGI #x having MBS service ID=A. In 1420, the AMF-1/MB-SMF-1 1406 may perform MBS broadcast setup with gNB 1404 for TMGI #x. In 1422, the gNB 1404 may provide broadcast MBS session configuration for MBS session #1 with TMGI #x. In 1424, the AF 1410 may create a MBS broadcast context with AMF-2/MB-SMF-2 1408, with TMGI #y having MBS service ID=A. In 1426, the AMF-2/MB-SMF-2 1408 may perform MBS broadcast setup with gNB 1404 for TMGI #y. In 1428, the gNB may be aware that the MBS service for TMGI #y is the same as for TMGI #x, based on the MBS service ID in both TMGIs being set to A. Accordingly, in 1430, the gNB 1404 may provide broadcast MBS session configuration for MBS session #1 with both TMGI #x and TMGI #y.

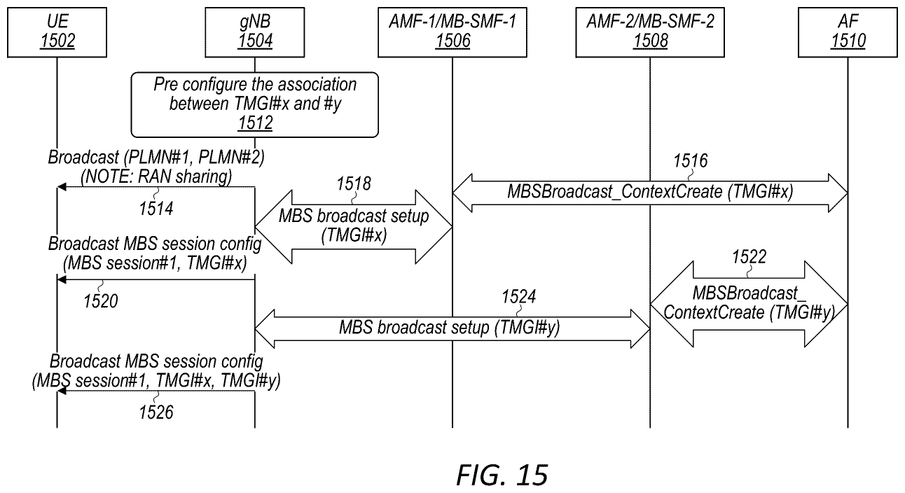

FIG. 15 is a signal flow diagram illustrating further details of an example scenario in which the association between multiple TMGIs can be configured to a gNB that is part of a RAN sharing deployment via OAM or other means, according to some embodiments. The illustrated scenario may include communication between a UE 1502, gNB 1504, AMF-1/MB-SMF-1 1506, AMF-2/MB-SMF-2 1508, and AF 1510. As shown, in 1512, the gNB may be aware that there is an association between TMGI #x and TMGI #y. In 1514, the gNB 1504 may establish a broadcast configuration with the UE 1502 in which PLMN #1 and PLMN #2 have RAN sharing. In 1516, the AF 1510 may create a MBS broadcast context with AMF-1/MB-SMF-1 1506, with TMGI #x. In 1518, the AMF-1/MB-SMF-1 1506 may perform MBS broadcast setup with gNB 1504 for TMGI #x. In 1520, the gNB 1504 may provide broadcast MBS session configuration for MBS session #1 with TMGI #x. In 1522, the AF 1510 may create a MBS broadcast context with AMF-2/MB-SMF-2 1508, with TMGI #y. In 1524, the AMF-2/MB-SMF-2 1508 may perform MBS broadcast setup with gNB 1504 for TMGI #y. Since the gNB 1504 may be aware that the MBS service for TMGI #y is the same as for TMGI #x, based on the preconfigured association between TMGI #x and TMGI #y, in 1526, the gNB 1504 may provide broadcast MBS session configuration for MBS session #1 with both TMGI #x and TMGI #y.

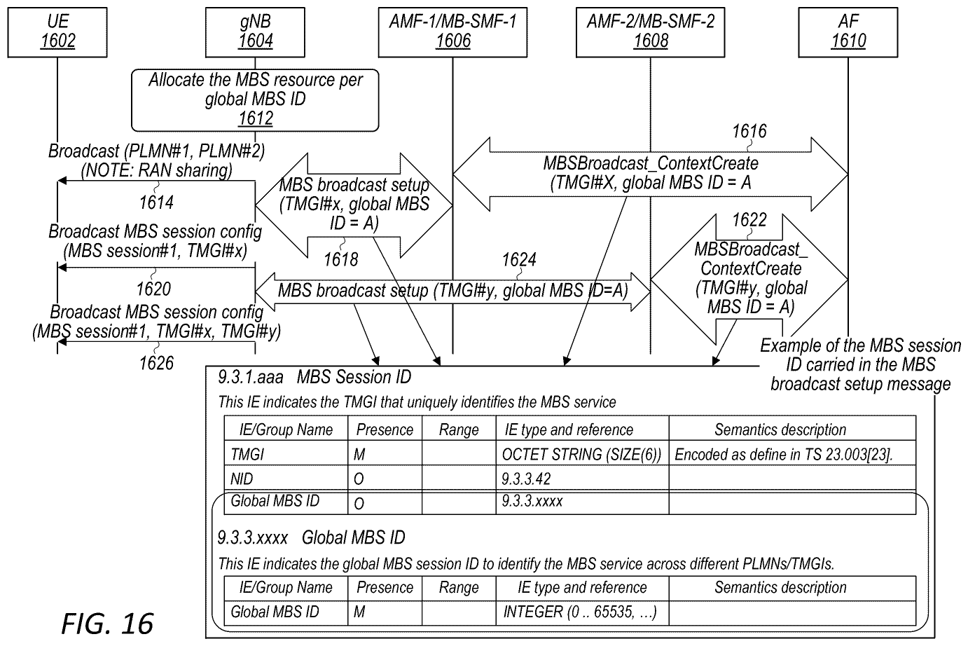

FIG. 16 is a signal flow diagram illustrating further details of an example scenario in which a new global MBS service ID may be introduced to associate multiple TMGIs with the same MBS service, according to some embodiments. The illustrated scenario may include communication between a UE 1602, gNB 1604, AMF-1/MB-SMF-1 1606, AMF-2/MB-SMF-2 1608, and AF 1610. In 1612, the gNB 1604 may be configured to allocate the MBS resource per global MBS service ID (e.g., rather than per TMGI). In 1614, the gNB 1604 may establish a broadcast configuration with the UE 1602 in which PLMN #1 and PLMN #2 have RAN sharing. In 1616, the AF 1610 may create a MBS broadcast context with AMF-1/MB-SMF-1 1606, with TMGI #x having global MBS ID=A. In 1618, the AMF-1/MB-SMF-1 1606 may perform MBS broadcast setup with gNB 1604 for TMGI #x, including indicating that the MBS service has global MBS ID=A. In 1620, the gNB 1604 may provide broadcast MBS session configuration for MBS session #1 with TMGI #x. In 1622, the AF 1610 may create a MBS broadcast context with AMF-2/MB-SMF-2 1608, with TMGI #y having global MBS ID=A. In 1624, the AMF-2/MB-SMF-2 1608 may perform MBS broadcast setup with gNB 1604 for TMGI #y including indicating that the MBS service has global MBS ID=A. The gNB may be aware that the MBS service for TMGI #y is the same as for TMGI #x, based on the global MBS ID associated with both TMGIs being set to A. Accordingly, in 1626, the gNB 1604 may provide broadcast MBS session configuration for MBS session #1 with both TMGI #x and TMGI #y.

As shown, FIG. 16 also illustrates possible MBS Session ID and Global MBS ID information element descriptions that could be included in 3GPP technical specifications as part of defining how such a global MBS ID parameter could be used in a 3GPP-based communication system, at least according to some embodiments. Note that the illustrated description sections are exemplary only, and variations or alternatives may also be possible.

Note that such a new global MBS service ID may be transparent to the UE (e.g., as in the illustrated scenario of FIG. 16) or can be configured together with TMGI to the UE, according to various embodiments. The UE may be able to use the global MBS ID information to identify MBS service in which the UE is interested in the Uu interface. The network may be able to use the global MBS ID to indicate the MBS multicast activation in the notification paging (e.g., for multicast cases).

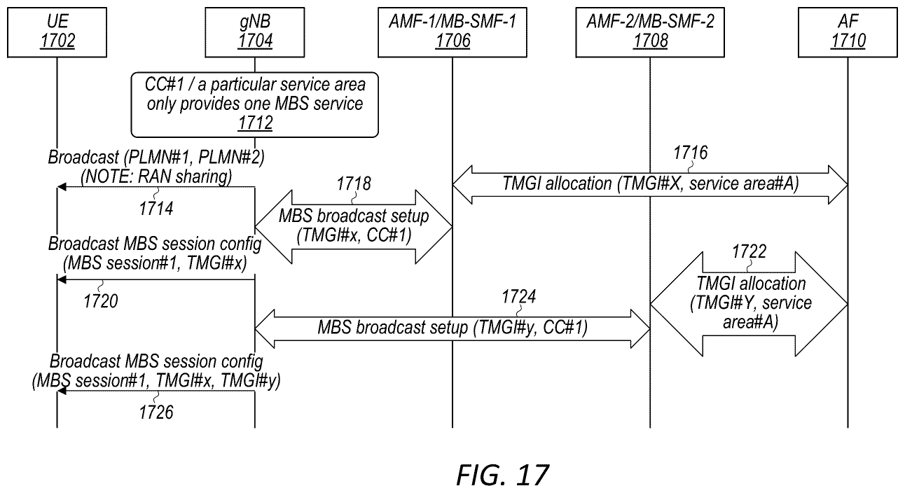

FIG. 17 is a signal flow diagram illustrating further details of an example scenario in which a special carrier can be configured to provide one MBS service, according to some embodiments. The illustrated scenario may include communication between a UE 1702, gNB 1704, AMF-1/MB-SMF-1 1706, AMF-2/MB-SMF-2 1708, and AF 1710. As shown, in 1712, the gNB may configure a carrier (“component carrier 1” or “CC #1”) and/or particular service area as only providing one MBS service. Thus, all the TMGIs which are delivered on CC #1 and/or in the configured service area may be known to refer to the same MBS session. In 1714, the gNB 1704 may establish a broadcast configuration with the UE 1702 in which PLMN #1 and PLMN #2 have RAN sharing. In 1716, the AF 1710 may provide a TMGI allocation to AMF-1/MB-SMF-1 1706, with TMGI #x, and with service area configured as “A”. In 1718, the AMF-1/MB-SMF-1 1706 may perform MBS broadcast setup with gNB 1704 for TMGI #x, with the MBS session configured for CC #1 based on the service area being configured as A. In 1720, the gNB 1704 may provide broadcast MBS session configuration for MBS session #1 with TMGI #x on CC #1. In 1722, the AF 1710 may provide a TMGI allocation to AMF-2/MB-SMF-2 1708, with TMGI #y, and with service area configured as “A”. In 1724, the AMF-2/MB-SMF-2 1708 may perform MBS broadcast setup with gNB 1704 for TMGI #y, with the MBS session configured for CC #1 based on the service area being configured as A. Since the gNB 1704 may be aware that the MBS service for TMGI #y is the same as for TMGI #x, based on the association with the special carrier CC #1, in 1726, the gNB 1704 may provide broadcast MBS session configuration for MBS session #1 with both TMGI #x and TMGI #y on CC #1.

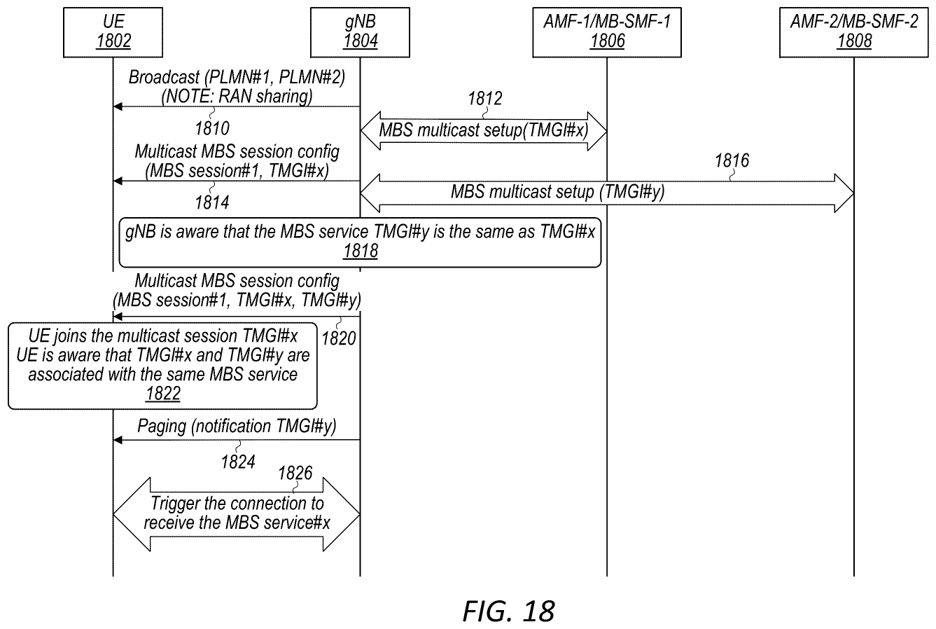

FIG. 18 is a signal flow diagram illustrating further details of possible UE operation in a scenario in which multiple TMGIs can be associated with one MBS multicast service/session, according to some embodiments. The illustrated scenario may include communication between a UE 1802, gNB 1804, AMF-1/MB-SMF-1 1806, and AMF-2/MB-SMF-2 1808. As shown, in 1810, the gNB 1804 may establish a broadcast configuration with the UE 1802 in which PLMN #1 and PLMN #2 have RAN sharing. In 1812, the AMF-1/MB-SMF-1 1806 may perform MBS multicast setup with gNB 1804 for TMGI #x. In 1814, the gNB 1804 may provide multicast MBS session configuration for MBS session #1 with TMGI #x. In 1816, the AMF-2/MB-SMF-2 1808 may perform MBS multicast setup with gNB 1804 for TMGI #y. In 1818, the gNB 1804 may be aware that the MBS service for TMGI #y is the same as for TMGI #x. Accordingly, in 1820, the gNB 1804 may provide multicast MBS session configuration for MBS session #1 with both TMGI #x and TMGI #y.

In 1822, the UE 1802 may join the multicast session TMGI #x. The UE 1802 may be aware that the TMGI #x and TMG #y are associated with the same MBS service, e.g., at least from the multicast MBS session configuration. In 1824, the UE may receive paging including a notification for TMGI #y. In 1826, the UE 1802 may trigger the connection to receive the MBS service based on the paging notification for TMGI #y and the knowledge that TMGI #x and TMG #y are associated. Thus, in such a scenario, a UE may be able to activate the MBS multicast session when any TMGI associated with its interested MBS service is indicated in paging, at least according to some embodiments.

In the following further exemplary embodiments are provided.

One set of embodiments may include a method, comprising: by a cellular base station associated with at least a first public land mobile network (PLMN) and a second PLMN: receiving multicast and broadcast services (MBS) session setup information for a MBS session from a network entity associated with the first PLMN; determining that the MBS session is associated with both the first PLMN and the second PLMN; and configuring the MBS session associated with both the first PLMN and the second PLMN.

According to some embodiments, the method further comprises: receiving MBS session setup information for the MBS session from a network entity associated with the second PLMN, wherein determining that the MBS session is associated with both the first PLMN and the second PLMN is based at least in part on receiving MBS session setup information for the MBS session from both the network entity associated with the first PLMN and the network entity associated with the second PLMN.

According to some embodiments, the method further comprises: receiving an indication that a first temporary mobile group identifier (TMGI) and a second TMGI are associated with each other, wherein the MBS session setup information received from the network entity associated with the first PLMN indicates the first TMGI for the MBS session, wherein the MBS session setup information received from the network entity associated with the second PLMN indicates the second TMGI for the MBS session.

According to some embodiments, the MBS session setup information received from the network entity associated with the first PLMN indicates a first temporary mobile group identifier (TMGI) for the MBS session, wherein the MBS session setup information received from the network entity associated with the second PLMN indicates a second TMGI for the MBS session, wherein a MBS service identification field for the first TMGI and the second TMGI are identical.

According to some embodiments, the MBS session setup information received from the network entity associated with the first PLMN includes MBS service identification information that uniquely identifies the MBS session across multiple PLMNs, wherein the MBS session setup information received from the network entity associated with the second PLMN includes MBS service identification information that uniquely identifies the MBS session across multiple PLMNs, wherein the MBS service identification information in the MBS session setup information received from the network entity associated with the first PLMN and the MBS service identification information in the MBS session setup information received from the network entity associated with the second PLMN are identical.

According to some embodiments, determining that the MBS session is associated with both the first PLMN and the second PLMN is based at least in part on a temporary mobile group identifier (TMGI) for the MBS session.

According to some embodiments, the TMGI for the MBS session is a shared TMGI associated with both the first PLMN and the second PLMN.

According to some embodiments, the method further comprises: configuring a component carrier to provide one MBS session, wherein the MBS session associated with both the first PLMN and the second PLMN is configured on the component carrier.

According to some embodiments, the MBS session setup information received from the network entity associated with the first PLMN indicates to setup the MBS session using the component carrier configured to provide one MBS session, wherein the method further comprises: receiving MBS session setup information for the MBS session from a network entity associated with the second PLMN, wherein the MBS session setup information received from the network entity associated with the second PLMN indicates to setup the MBS session using the component carrier configured to provide one MBS session, wherein determining that the MBS session is associated with both the first PLMN and the second PLMN is based at least in part on the MBS session setup information received from both the network entity associated with the first PLMN and the network entity associated with the second PLMN indicating to setup the MBS session using the component carrier configured to provide one MBS session.

According to some embodiments, the method further comprises: configuring a service area to provide one MBS session, wherein the MBS session associated with both the first PLMN and the second PLMN is configured for the service area.

According to some embodiments, the MBS session setup information received from the network entity associated with the first PLMN indicates to setup the MBS session using the service area configured to provide one MBS session, wherein the method further comprises: receiving MBS session setup information for the MBS session from a network entity associated with the second PLMN, wherein the MBS session setup information received from the network entity associated with the second PLMN indicates to setup the MBS session using the service area configured to provide one MBS session, wherein determining that the MBS session is associated with both the first PLMN and the second PLMN is based at least in part on the MBS session setup information received from both the network entity associated with the first PLMN and the network entity associated with the second PLMN indicating to setup the MBS session using the service area configured to provide one MBS session.

Another set of embodiments may include a cellular base station, comprising: one or more processors; and a memory having instructions stored thereon, which when executed by the one or more processors, perform steps of the method of any of the preceding examples.

Yet another set of embodiments may include a method, comprising: by a wireless device: establishing a wireless link with a cellular base station; receiving multicast and broadcast services (MBS) session configuration information from the cellular base station, wherein the MBS session configuration information configures a MBS session that is associated with multiple public land mobile networks (PLMNs).

According to some embodiments, the MBS session configuration information indicates that at least a first temporary mobile group identifier (TMGI) and a second TMGI are associated with the MBS session.

According to some embodiments, the first TMGI is associated with a PLMN that is associated with the wireless device, wherein the second TMGI is associated with a PLMN that is not associated with the wireless device, wherein the method further comprises: receiving content for the MBS session that is identified via the second TMGI; and identifying that the content is for the MBS session based at least in part on the second TMGI.

According to some embodiments, the MBS session is a multicast MBS session, wherein the first TMGI is associated with a PLMN that is associated with the wireless device, wherein the second TMGI is associated with a PLMN that is not associated with the wireless device, wherein the method further comprises: receiving paging for the multicast MBS session for the second TMGI; and triggering a connection to receive the multicast MBS session based at least in part on the second TMGI.

According to some embodiments, the MBS session configuration information includes MBS service identification information that uniquely identifies the MBS session across multiple PLMNs.

According to some embodiments, a temporary mobile group identifier (TMGI) for the MBS session is a shared TMGI associated with the multiple PLMNs.

Still another set of embodiments may include a wireless device, comprising: one or more processors; and a memory having instructions stored thereon, which when executed by the one or more processors, perform steps of the method of any of the preceding examples.

A further set of embodiments may include a computer program product, comprising computer instructions which, when executed by one or more processors, perform steps of the method of any of the preceding examples.

A further exemplary embodiment may include a method, comprising: performing, by a device, any or all parts of the preceding examples.

Another exemplary embodiment may include a device, comprising: an antenna; a radio coupled to the antenna; and a processor operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processor configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, from a network entity associated with a first public land mobile network (PLMN), multicast and broadcast services (MBS) session setup information for a MBS session associated with the first PLMN with radio access network (RAN) sharing;
determining that the MBS session is to be associated with both the first PLMN and a second PLMN with the RAN sharing; and
configuring the MBS session associated with both the first PLMN and the second PLMN.

2. The method of claim 1, wherein the method further comprises:
receiving MBS session setup information for the MBS session from a network entity associated with the second PLMN,
wherein determining that the MBS session is to be associated with both the first PLMN and the second PLMN is based at least in part on receiving MBS session setup information for the MBS session from both the network entity associated with the first PLMN and the network entity associated with the second PLMN.

3. The method of claim 2, wherein the method further comprises:
receiving an indication that a first temporary mobile group identifier (TMGI) and a second TMGI are associated with each other,
wherein the MBS session setup information received from the network entity associated with the first PLMN indicates the first TMGI for the MBS session,
wherein the MBS session setup information received from the network entity associated with the second PLMN indicates the second TMGI for the MBS session.

4. The method of claim 2,
wherein the MBS session setup information received from the network entity associated with the first PLMN indicates a first temporary mobile group identifier (TMGI) for the MBS session,
wherein the MBS session setup information received from the network entity associated with the second PLMN indicates a second TMGI for the MBS session,
wherein a MBS service identification field for the first TMGI and the second TMGI are identical.

5. The method of claim 2,
wherein the MBS session setup information received from the network entity associated with the first PLMN includes MBS service identification information that uniquely identifies the MBS session across multiple PLMNs,
wherein the MBS session setup information received from the network entity associated with the second PLMN includes MBS service identification information that uniquely identifies the MBS session across multiple PLMNs,
wherein the MBS service identification information in the MBS session setup information received from the network entity associated with the first PLMN and the MBS service identification information in the MBS session setup information received from the network entity associated with the second PLMN are identical.

6. The method of claim 1,
wherein determining that the MBS session is to be associated with both the first PLMN and the second PLMN is based at least in part on a temporary mobile group identifier (TMGI) for the MBS session.

7. The method of claim 6,
wherein the TMGI for the MBS session is a shared TMGI associated with both the first PLMN and the second PLMN.

8. The method of claim 1, wherein the method further comprises:
configuring a component carrier to provide one MBS session,
wherein the MBS session to be associated with both the first PLMN and the second PLMN is configured on the component carrier.

9. The method of claim 8,
wherein the MBS session setup information received from the network entity associated with the first PLMN indicates to setup the MBS session using the component carrier configured to provide one MBS session, wherein the method further comprises:
receiving MBS session setup information for the MBS session from a network entity associated with the second PLMN, wherein the MBS session setup information received from the network entity associated with the second PLMN indicates to setup the MBS session using the component carrier configured to provide one MBS session,
wherein determining that the MBS session is associated with both the first PLMN and the second PLMN is based at least in part on the MBS session setup information received from both the network entity associated with the first PLMN and the network entity associated with the second PLMN indicating to setup the MBS session using the component carrier configured to provide one MBS session.

10. The method of claim 1, wherein the method further comprises:
configuring a service area to provide one MBS session,
wherein the MBS session associated with both the first PLMN and the second PLMN is configured for the service area.

11. The method of claim 10,
wherein the MBS session setup information received from the network entity associated with the first PLMN indicates to setup the MBS session using the service area configured to provide one MBS session, wherein the method further comprises:
receiving MBS session setup information for the MBS session from a network entity associated with the second PLMN, wherein the MBS session setup information received from the network entity associated with the second PLMN indicates to setup the MBS session using the service area configured to provide one MBS session,
wherein determining that the MBS session is associated with both the first PLMN and the second PLMN is based at least in part on the MBS session setup information received from both the network entity associated with the first PLMN and the network entity associated with the second PLMN indicating to setup the MBS session using the service area configured to provide one MBS session.

12. A method, comprising:
communicating via a wireless link with a cellular base station in association with radio access network (RAN) sharing; and
receiving multicast and broadcast services (MBS) session configuration information from the cellular base station, wherein the MBS session configuration information configures a MBS session that is associated with a first public land mobile networks (PLMN) and a second PLMN.

13. The method of claim 12,
wherein the MBS session configuration information indicates that at least a first temporary mobile group identifier (TMGI) and a second TMGI are associated with the MBS session.

14. The method of claim 13,
wherein the first TMGI is associated with a PLMN that is associated with a wireless device, wherein the second TMGI is associated with a PLMN that is not associated with the wireless device, wherein the method further comprises:
receiving content for the MBS session that is identified via the first TMGI; and
identifying that the content is for the MBS session based at least in part on the first TMGI.

15. The method of claim 13,
wherein the MBS session is a multicast MBS session,
wherein the first TMGI is associated with a PLMN that is associated with a wireless device, wherein the second TMGI is associated with a PLMN that is not associated with the wireless device, wherein the method further comprises:
receiving paging for the multicast MBS session for the first TMGI; and
triggering a connection to receive the multicast MBS session based at least in part on the first TMGI.

16. The method of claim 13,
wherein the MBS session configuration information includes MBS service identification information that uniquely identifies the MBS session across multiple PLMNs.

17. The method of claim 12,
wherein a temporary mobile group identifier (TMGI) for the MBS session is a shared TMGI associated with the first PLMN and second PLMN.

18. An apparatus, comprising:
a processor configured to, when executing instructions stored in a memory, perform operations comprising:
receiving, from a network entity associated with a first public land mobile network (PLMN), multicast and broadcast services (MBS) session setup information for a MBS session associated with the first PLMN with radio access network (RAN) sharing;
determining that the MBS session is to be associated with both the first PLMN and a second PLMN with the RAN sharing; and
configuring the MBS session associated with both the first PLMN and the second PLMN.

19. The apparatus of claim 18, the operations further comprising:
receiving MBS session setup information for the MBS session from a network entity associated with the second PLMN,
wherein determining that the MBS session is to be associated with both the first PLMN and the second PLMN is based at least in part on receiving MBS session setup information for the MBS session from both the network entity associated with the first PLMN and the network entity associated with the second PLMN.

20. The apparatus of claim 18,
wherein determining that the MBS session is to be associated with both the first PLMN and the second PLMN is based at least in part on a temporary mobile group identifier (TMGI) for the MBS session.
